(19) United States
(12) Patent Application Publication
(10) Pub. No.: US 2002/0180585 A1
(43) Pub. Date: Dec. 5, 2002

(54) Information terminal with built-in fingerprint recognizer

(76) Inventors: Jee-Hoon Kim, Seoul (KR); Eung-Ryeol Ko, Seoul (KR); Soon-Won Jung, Seoul (KR); Hwi-Seok Lee, Seoul (KR); Byung-Jin Lee, Seoul (KR)

Correspondence Address: EPSTEIN, EDELL, SHAPIRO, FINNAN & LYTLE, LLC, 1901 RESEARCH BOULEVARD, SUITE 400, ROCKVILLE, MD, 20850, US

(21) Appl. No.: 10/149,768

(22) PCT Filed: Dec. 8, 2000
(86) PCT No.: PCT/KR00/01423

(30) Foreign Application Priority Data
Dec. 18, 1999 (KR) 1999/58894

(51) Int. Cl. H04Q 1/00

(52) U.S. Cl. 340/5.53; 340/5.74

(57) ABSTRACT

Disclosed is an information terminal with a built-in fingerprint recognizer for verifying a user's fingerprint and permitting the user to use the information terminal according to a verified result, wherein the information terminal comprises a liquid crystal display (LCD) with a backlight and a thin film transistor (TFT) fingerprint reader, which is incorporated with the LCD, for reading the user's fingerprint, such that the portable phone is reduced in size thereof, it is easier to perform a fingerprint reading, and the external appearance becomes graceful.

### FIELD OF THE INVENTION

The present invention relates to an information terminal with a built-in liquid crystal type fingerprint recognizer, and more particularly, the present invention relates to an information terminal having a fingerprint recognizer therein, such that fingerprint reading can be easily accomplished with a fine external appearance and reduced size.

### DESCRIPTION OF THE PRIOR ART

Typical information terminals include, by way of example, a portable phone (also referred to as a mobile phone), a personal digital assistant (PDA), etc.

The portable phone is generally used for wireless communication by reciprocating radio-frequency signal with a base station via a certain communication method, by way of example, Code Division Multiple Access (CDMA). This is a personal portable communication equipment that has been popularized recently. PDA is a portable Personal Computer (PC) that is capable of collecting, storing, writing, and retrieving information, and communicating as well.

Information terminals generally have a lock function for excluding unauthorized uses. A predetermined password should be entered to unlock the lock function, which is actually inconvenient for a legitimate user. Still worse, a password may be easily disclosed. So, studies on the information terminal having a built-in fingerprint recognizer are in full swing these days.

Fingerprint input means for a fingerprint recognizer mounted on the information device thus described includes an optical type and a solid-state type. The optical type fingerprint reader has a difficulty in being adapted to the information terminals requiring small size, since the optical fingerprint reader should be equipped with a prism and focusing means. Therefore, the studies on the information terminal having an intrinsic fingerprint recognizer places emphasis on a solid-state type.

An example of a portable phone adopting such a solid-state fingerprint reader, is shown in FIG. 1. Even though FIG. 1 shows a solid-state fingerprint reader (PS) installed around a keypad, the PS may be installed on the side of a body.

However, there is a problem in the solid-state fingerprint reader thus described in that durability is low and life cycle is short, resulting in an electrostatic discharge occurring due to finger touch on a solid-state substrate which is sensitive to voltage and current. There is another problem in that the portable phone becomes bulky, such that the external appearance thereof is not quite becoming because of an area externally occupied by the fingerprint reader.

### SUMMARY OF THE INVENTION

The present invention is disclosed to solve the aforementioned problems and it is an object of the present invention to provide an information terminal with a built-in fingerprint recognizer comprising a thin film transistor (TFT) fingerprint reader adapted to reduce size and simplify a finger-print input with a fine external outlook, being incorporated with a liquid crystal display (LCD).

To achieve the above objects, the present invention provides an information terminal, the terminal comprising a liquid crystal display (LCD) with a backlight and a TFT fingerprint reader, which is incorporated with an LCD for reading a user's fingerprint.

The TFT fingerprint reader comprises a TFT for sensor (sensor TFT) and a TFT for switching (switching TFT), where the TFT fingerprint reader uses as a light source the backlight of the LCD. The information terminal may be either a portable phone or a personal digital assistant (PDA).

### BRIEF DESCRIPTION OF THE DRAWINGS

The above and the other objects and features of the present invention will become apparent from the following description given in conjunction with the accompanying drawings, in which:

FIG. 1 is a perspective view for showing a conventional portable phone having a fingerprint recognizer;

FIG. 2 is a perspective view for showing a portable phone according to a first preferred embodiment of the present invention;

FIG. 3 is a perspective view for showing PDA according to a second preferred embodiment of the present invention;

FIG. 4 is a brief diagram for showing an installation of the fingerprint reader in FIGS. 2 and 3;

FIG. 5 is a cross-sectional view for showing a structure of the fingerprint reader in FIG. 4;

FIG. 6 is a schematic diagram of the fingerprint reader in FIG. 5; and

FIG. 7 is a block diagram for explaining the control of a portable phone having the built-in fingerprint reader shown in FIG. 2.

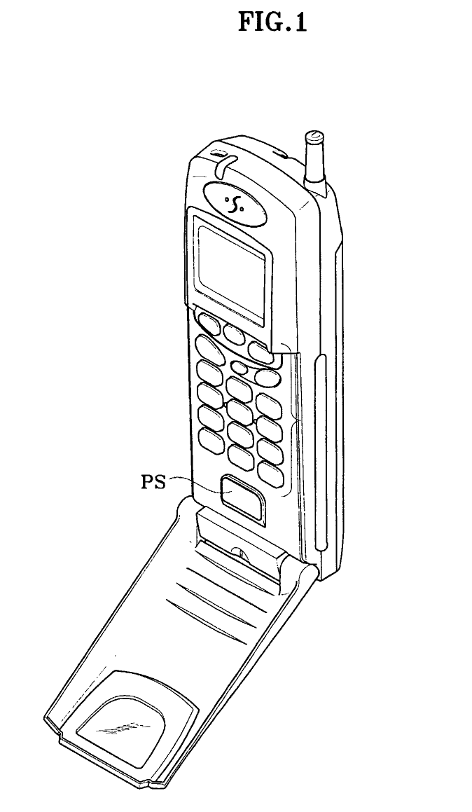

### DETAILED DESCRIPTION OF THE PREFERRED EMBODIMENTS

Hereinafter, the structure and operation of preferred embodiments of the present invention will be described in detail with reference to the drawings.

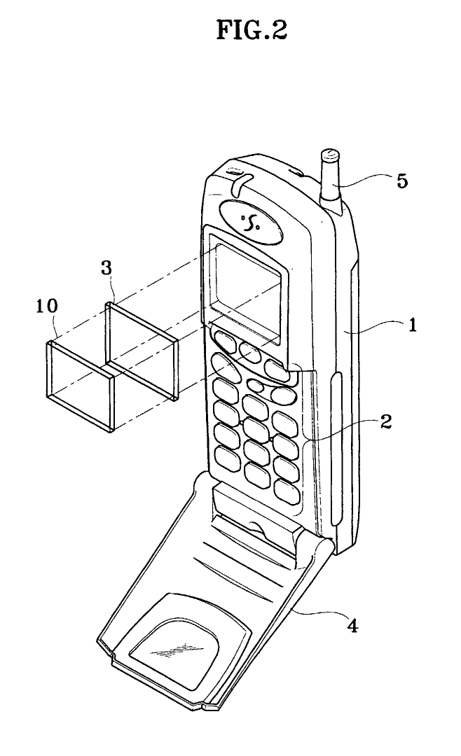

FIG. 2 is a perspective view for illustrating a first embodiment of the present invention, a portable phone with a built-in fingerprint recognizer. It can be noticed from FIG. 2 that the portable phone is comprised of a body 1, a keypad 2 arranged on the front of a body 1, a liquid crystal display (LCD) 3 located over the keypad 2, a flip-lid 4 for covering the keypad 2, and an antenna 5 mounted on the top of the body 1.

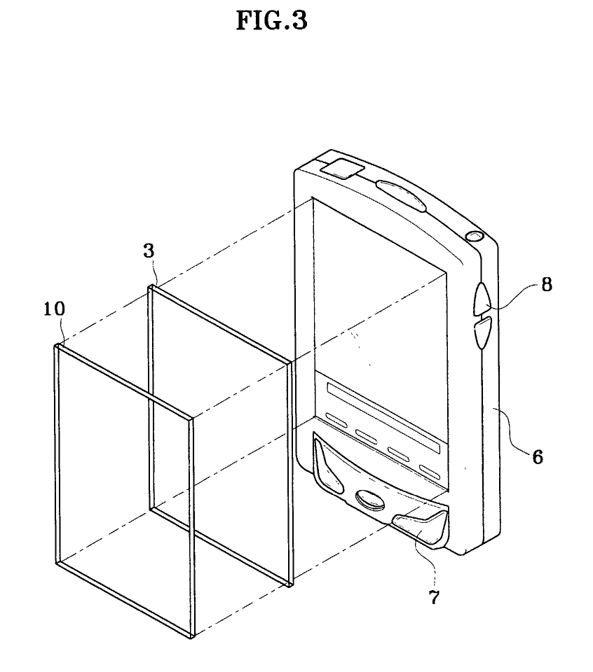

FIG. 3 is a perspective view for showing a second embodiment of the present invention, a personal display assistant (PDA) with a built-in fingerprint recognizer. As is shown, the LCD 3 is attached to the front of a body 6, and multiple operation buttons 7 and 8 are arranged on the front and the side of the body 6.

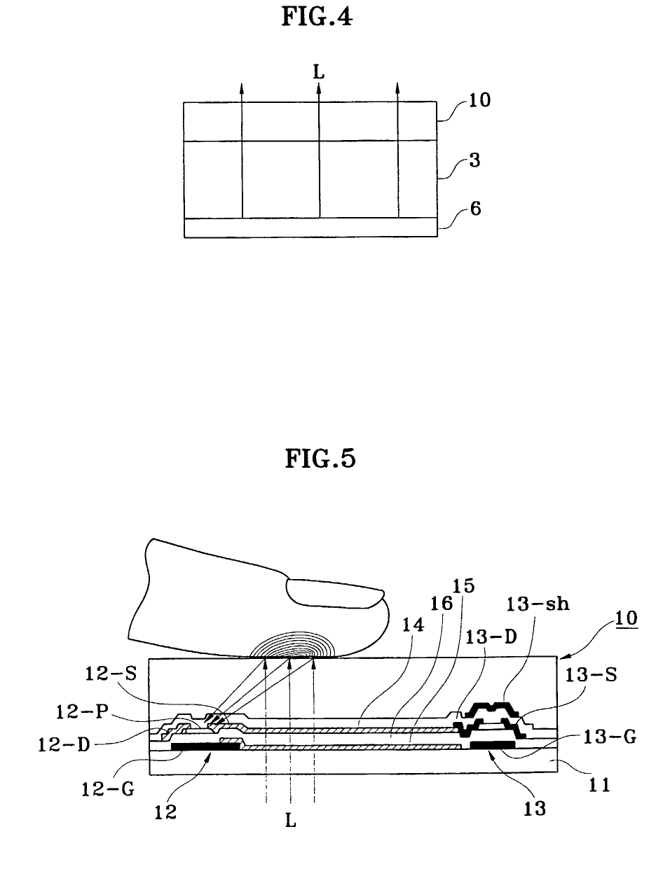

Meanwhile, as is shown in FIG. 4, a backlight 6 is positioned beneath the LCD 3. On the LCD 3, a fingerprint reader 10 is overlapped, which is a thin film transistor (TFT) type fingerprint reader and is transparent enough to transmit light back and forth. Therefore, a message may be displayed on the LCD 3 through the fingerprint reader 10.

In the fingerprint reader 10, with reference to FIG. 5, a plurality of sensor TFTs 12 and switching TFTs 13 are arrayed on a transparent substrate 11 each at a regular interval. A source 12-S of the sensor TFT 12 and a drain 13-D of the switching TFT 13 are interconnected via a first electrode 14. A second electrode 15 is connected to a gate 12-G of the sensor TFT 12, wherein the second electrode 15 is separated from the first electrode 14 by a transparent insulator layer 16. Thus, there exists a capacitance Csto between the first electrode 14 and the second electrode 15. This capacitance is charged in proportion to the amount of a light incident upon the sensor TFT 12. It is desirable that the first and second electrode 14 and 15 are of transparent materials.

Between the drain 12-D and the source 12-S of the sensor TFT 12, a photoconductive layer 12-P (such as amorphous-Si:H) is formed. When a light stronger than a critical value is irradiated to the photoconductive layer 12-P, the drain 12-D and the source 12-S are electrically short-circuited.

Therefore, if a user touches his or her fingerprint to the fingerprint reader 10, a light from the backlight 6 is reflected on the fingerprint pattern and is incident on the photoconductive layer 12-P, whereby sensor TFT 12 is short-circuited and the capacitance Csto is charged in proportion to the incident light.

On the other hand, over the drain 13-D and the source 12-S of the switching TFT 13, a shield 13-sh is formed in order not to be irradiated by light.

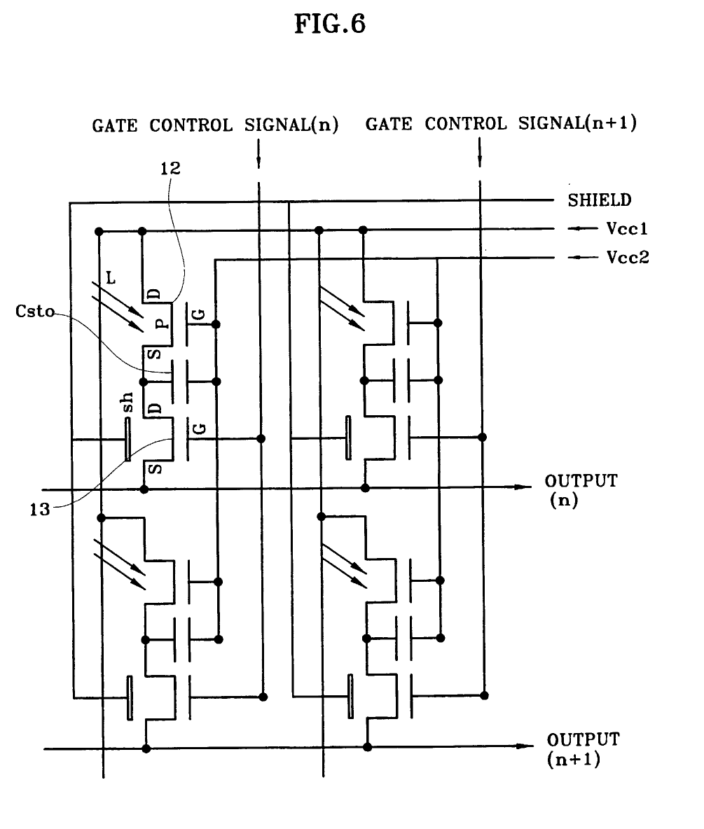

An equivalent circuit of the above fingerprint reader is illustrated in FIG. 6. As shown, a certain level of DC voltage Vcc1 is applied to the drain 12-D, and a certain level of bias voltage Vcc2 is applied to the gate 12-G of the sensor TFT 12.

The gate 13-G of the switching TFT 13 is switched by a gate control signal from a gate controller (not shown). The gate controller generates gate control signals for switching the switching TFT 13 at each frame that is predetermined to adequately scan a fingerprint pattern. By switching the switching TFT 13, a frame to fingerprint image to be scanned can be formed.

In addition, the source 13-S of the switching TFT 13 is connected to an amplifier (not shown). When the switching TFT 13 is turned on, the voltage is output from the charged capacitor in proportion to the amount of charges. The amplifier amplifies the signal output from the source 12-S of the sensor TFT 12. The signal output from the amplifier is provided to a multiplexer for outputting a single output signal.

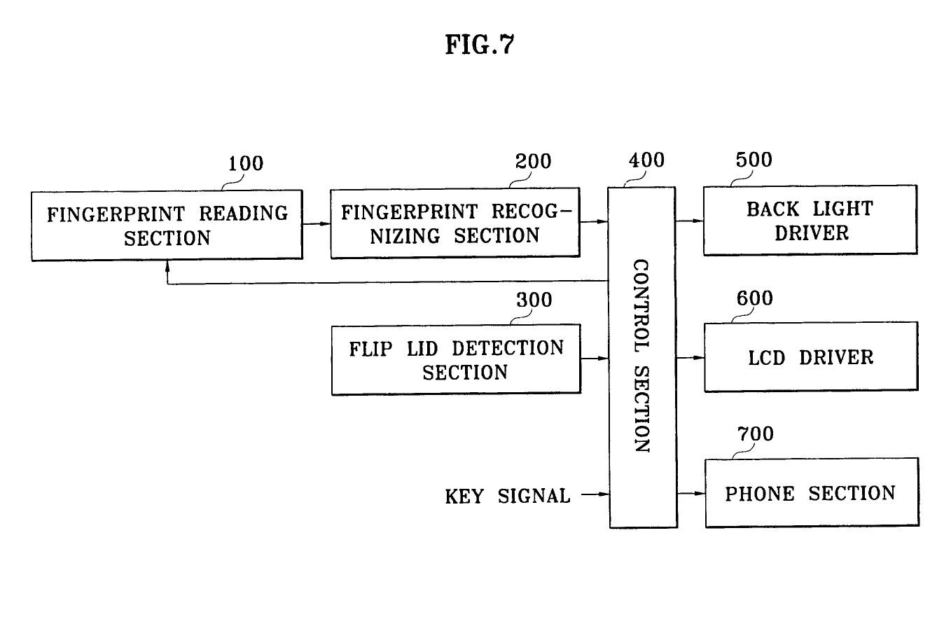

FIG. 7 is a block diagram for explaining the control of a portable phone having a built-in fingerprint reader shown in FIG. 2. As shown, the portable phone comprises a fingerprint reading section 100, a fingerprint recognizing section 200, a flip-lid detection section 300 for detecting whether or not the flip-lid is open, a control section 400, a backlight driver 500, an LCD driver 600, and a phone section 700.

The fingerprint reading section 100 which comprises the fingerprint reader 10 converts the fingerprint read signal from the fingerprint reader 10 to an image data, and provides same to the fingerprint recognizing section 200.

The fingerprint recognizing section 200 compares the fingerprint image data with the registered fingerprint data, and provides a resultant signal to the control section 400 when the comparison is completed.

If the flip-lid detection section 300 provides to the control section 400 a data that the flip-lid 4 is open, or if a key signal is provided to the control section 400, the control section 400 is switched into a fingerprint read mode. This enables the backlight driver 500 to turn the backlight on, and the LCD driver 600 to display messages indicating that the current mode is a fingerprint read mode.

In addition to the above, the control section 400 provides to the fingerprint reading section 100 a control signal for instructing the fingerprint reading section 100 to read a user's fingerprint. If the control section 400 determines that the read fingerprint coincides with the pre-registered fingerprint, the phone section 700 is enabled to be available.

The backlight driver 500 provides a voltage signal to the backlight 6 in response to the control signal from the control section 400 to turn on the backlight 6. Successively, the LCD driver 600 enables the LCD to display messages, e.g., “to put your finger on the fingerprint reader”, in response to the display signal from the control section 400.

The phone section 700 comprises various Integrated Circuit (ICs) and other circuits required for functional operation of the portable phone. The phone can only function when the control section 400 issues a control signal permitting to perform the function.

The operation of the portable phone will be described with regard to FIGS. 2 and 4 to 7.

First, when a user opens the flip-lid 4 to make a call, the flip-lid detection section 300 provides to the control section 400 a signal indicating that the flip-lid 4 is open. The control section 400 changes the mode into a fingerprint reading mode, provides a backlight-turn-on signal to the backlight driver 500, issues a display signal to the LCD driver 600, and instructs the fingerprint reading section 100 to read a fingerprint.

The backlight 6 positioned at the back of the LCD 3 is turned on by the signal from the control section 400, and the emitted light L is transmitted through the LCD 3 and the fingerprint reader 10.

Also, the LCD 3 displays a message requesting a finger touch according to the signal from the control section 400. Since the fingerprint reader 10 is transparent, a user can see the message on the LCD 3 through the fingerprint reader 10.

Simultaneously, the drive and bias voltages Vcc1 and Vcc2 are provided to the sensor TFT 12 by the control signal from the control section 400. The gate control signal from the gate controller is provided to the switching TFT 13, thereby causing the switching TFT 13 to be switched at each frame.

At this time, if a user touches his or her fingerprint on the fingerprint reader 10, the light L from the backlight 6 is reflected on the fingerprint and is incident on the fingerprint reader 10. Since reflexibility is different from each fingerprint pattern, the intensity of the light incident on the sensor TFT 12 is different from position to position. That is, the light is reflected smaller on the valley portion of the fingerprint pattern, while greater on the hill portion of the fingerprint pattern.

Since the photoconductive layer 12-P on the sensor TFT 12 is made to respond to the light incident on a critical intensity, only part of the sensor TFT 12 is turned on, while other part of the sensor TFT 12 remains turned off, according to the fingerprint pattern.

The switching TFT 13 is turned on by the gate control signals from the gate controller at each frame period. Therefore, the sensor TFT 12, turned on by the light reflected on the fingerprint light, outputs a certain level of photo-generated signal through the switching turned-on TFT 13, while the sensor TFT 12 remaining turned-off does not produce any signal.

The signals thus output are amplified by an amplifier and converted to a single signal by a multiplexer. The fingerprint reading section 100 converts the fingerprint read signal from the multiplexer to an image data, and provides same to the fingerprint recognizing section 200.

The fingerprint recognizing section 200 compares the fingerprint image data with the registered fingerprint data, and, after comparison, provides the result signal to the control section 400.

If the control section 400 determines that the read fingerprint coincides with the pre-registered fingerprint, the phone section 700 is enabled to be available, while if not, the phone function is denied.

The phone section 700 can operate only when the control section 400 issues a control signal permitting the phone to do the function. Resultantly, a user can use the portable phone when his or her fingerprint coincides with the pre-registered fingerprint.

Thus far, the description is limited in the flip-lid type portable phone, however, it should be noted that a fingerprint reading mode in the PDA without a flip-lid can be achieved by manipulating a keypad instead of opening the flip-lid.

Additionally, in case of PDA, fingerprint reading can be accomplished at the step of entering a password prescribed according to importance of information. By doing so, unauthorized person is denied an access to the important information stored in PDA itself or another server by communication.

As apparent from the foregoing, there is an advantage in the information terminal with built-in fingerprint recognizer thus described according to the present invention in that since a TFT fingerprint reader is incorporated with an LCD of the conventional information terminal, an additional site occupied by the fingerprint reader is unnecessary. Thus, the portable phone is reduced in size, it is easier to perform a fingerprint reading, and the external appearance becomes graceful.

What is claimed is:

1. An information terminal with a built-in fingerprint recognizer, which verifies a user's fingerprint and permitting a user to use the information terminal according to the verified result, the information terminal comprising
a liquid crystal display (LCD) with a backlight, and
a thin film transistor (TFT) fingerprint reader, incorporated with the LCD for reading the user's fingerprint.

2. The information terminal with a built-in fingerprint recognizer according to claim 1, wherein the TFT fingerprint reader comprises a TFT for sensor (sensor TFT) and a TFT for switching (switching TFT).

3. The information terminal with a built-in fingerprint recognizer according to claim 1, wherein the TFT fingerprint reader uses backlight of the LCD as a light source.

4. The information terminal with a built-in fingerprint recognizer according to claim 2, wherein the TFT fingerprint reader uses backlight of the LCD as a light source.

5. The information terminal with a built-in fingerprint recognizer according to claim 1, wherein the information terminal is a portable phone.

6. The information terminal with a built-in fingerprint recognizer according to claim 2, wherein the information terminal is a portable phone.

7. The information terminal with a built-in fingerprint recognizer according to claim 3, wherein the information terminal is a portable phone.

8. The information terminal with a built-in fingerprint recognizer according to claim 4, wherein the information terminal is a portable phone.

9. The information terminal with a built-in fingerprint recognizer according to claim 1, wherein the information terminal is a personal digital assistant (PDA).

10. The information terminal with a built-in fingerprint recognizer according to claim 2, wherein the information terminal is a personal digital assistant (PDA).

11. The information terminal with a built-in fingerprint recognizer according to claim 3, wherein the information terminal is a personal digital assistant (PDA).

12. The information terminal with a built-in fingerprint recognizer according to claim 4, wherein the information terminal is a personal digital assistant (PDA).
